(19) United States
(12) Patent Application Publication
(10) Pub. No.: US 2016/0255012 A1
(43) Pub. Date: Sep. 1, 2016

(54) METHOD FOR MITIGATION OF UNAUTHORIZED DATA TRANSFER OVER DOMAIN NAME SERVICE (DNS)

(71) Applicant: CHECK POINT SOFTWARE TECHNOLOGIES LTD., TEL AVIV (IL)

(72) Inventors: Liad MIZRACHI, Tel Aviv (IL); Oded VANUNU, Tel Aviv (IL); Avi GIMPEL, Tel Aviv (IL); Dikla BARDA, Tel Aviv (IL); Roi PAZ, Tel Aviv (IL)

(21) Appl. No.: 14/631,881

(22) Filed: Feb. 26, 2015

(51) Int. Cl. H04L 12/911; H04L 29/12; H04L 29/08; H04L 29/06

(52) U.S. Cl. CPC H04L 47/70; H04L 69/22; H04L 61/1511; H04L 67/1036

(57) ABSTRACT

Methods and systems for prevent unauthorized use of a Domain Name System (DNS) channel in an organization are disclosed. These methods and systems comprise elements of hardware and software for receiving a packet; determining whether the packet is a DNS packet or a non-DNS packet; if the packet is a DNS packet, determining whether the destination address of the packet denotes a legitimate DNS server; and, according to whether the destination address of the packet denotes a legitimate DNS server, permitting the packet.

### TECHNICAL FIELD OF THE INVENTION

The present invention relates to methods and systems for preventing unauthorized digital content from entering into or exiting from an organization's network.

### BACKGROUND

Organizations frequently implement policies regarding the type of digital content which enters or exits the organization's network. For example, an organization might prevent its internal users from accessing streaming video. Similarly, an organization might scrutinize data exiting over HTTP to ensure that there is no leaking of confidential information. Frequently these policies are enforced by devices such as firewalls.

The Domain Name Service (DNS) is an essential service used for web browsing and other applications. The DNS provides user computers and devices with a service to translate domain names such as www.xyz.com to, for example, 32-bit IPv4 addresses that can be used to access, for example, web servers over the internet.

Due to its utility and ubiquitousness, entry/exit of DNS packet traffic is generally permitted by organization firewall devices. However the availability of DNS provides an opportunity for a non-compliant user or for malware to circumvent the organization's policies using a technique known as “DNS tunneling”.

In DNS tunneling, the user or malware creates packets which may not comply with organization policy and then places them in the payload portions of ordinary DNS packets with ordinary DNS headers (i.e. the noncomplying user or the malware “tunnels” the packets in DNS). These DNS packets are then sent to a DNS server residing outside the organization, for example a rogue DNS server. The organization's stateful inspection firewall is often configured to permit outgoing packets (i.e., from inside the organization to outside the organization) that contain DNS Requests. The rogue DNS Server can then “untunnel” the original non-compliant packets, and then forward them or store the data contained in them. Additionally, the rogue DNS Server may in turn encapsulate unauthorized data into the payloads of DNS Response packets and send these DNS Response packets back to the non-complying user or malware. The stateful inspection firewall frequently permits these DNS Response packets to enter the organization's network, because they are responses to permitted requests that were made from inside the organization's network.

### SUMMARY OF THE INVENTION

The present invention provides methods and systems for intercepting outgoing Domain Name Service (DNS) packets, confirming the legitimacy of the DNS server addressed in the DNS packet, and blocking or modifying a DNS packet if the address of the DNS server cannot be confirmed as legitimate.

This document references terms that are used consistently or interchangeably herein. These terms, including variations thereof are as follows:

A “computer” includes machines, computers and computing or computer systems (for example, physically separate locations or devices), servers, computer and computerized devices, processors, processing systems, computing cores (for example, shared devices.), and similar systems, workstations, modules and combinations of the aforementioned. The aforementioned “computer” may be in various types, such as a personal computer (e.g., laptop, desktop, tablet computer), or any type of computing device, including mobile devices that can be readily transported from one location to another location (e.g., smartphone, personal digital assistant (PDA), mobile telephone or cellular telephone).

A “server” is typically a remote computer or remote computer system, or computer program therein, in accordance with the “computer” defined above, that is accessible over a communications medium, such as a communications network or other computer network, including the Internet. A “server” provides services to or performs functions for, other computer programs (and their users), in the same or other computers. A server may also include a virtual machine, a software based emulation of a computer.

An “application”, includes executable software, and optionally, any graphical user interfaces (GUI), through which certain functionality may be implemented.

The term “linked” as used herein includes both wired or wireless links, either direct or indirect, and placing the computers, including, servers, components and the like, in electronic and/or data communications with each other.

Embodiments of the present invention are directed to a method, which is computer-implemented, for preventing unauthorized use of a DNS channel. The method comprises: receiving a packet determining whether the packet is a DNS packet or a non-DNS packet, when the packet is a DNS packet; determining whether the destination address of the packet denotes a legitimate DNS server; and according to whether the destination address of the packet denotes a legitimate DNS server, permitting the packet.

Optionally, the method determines whether a DNS server is legitimate by referring to a whitelist of known legitimate DNS server Internet Protocol (IP) addresses

Optionally, the method additionally comprises: discarding the packet, if the destination address of the packet does not refer to a DNS server known to be legitimate.

Optionally, the method additionally comprises: modifying the destination address of the packet to denote a legitimate DNS Server, if the original destination address does not denote a legitimate DNS server.

Optionally, the method is embodied in a serve

Optionally, the method is embodied in a device comprising a firewall.

Embodiments of the present invention are directed to a computer system for preventing unauthorized use of a DNS channel. The computer system comprises: a storage medium for storing computer components; and a computerized processor for executing the computer components. The computer components comprise: a first computer component for receiving a packet; a second computer component for determining whether the packet is a DNS packet or a non-DNS packet; a third computer component for, when the packet is a DNS packet, determining whether the destination address of the packet denotes a legitimate DNS server; and, a fourth computer component for, according to whether the destination address of the packet denotes a legitimate DNS server, permitting the packet.

Optionally, the fourth computer component determines whether a DNS server is legitimate is determined by referring to a whitelist of known legitimate DNS server IP addresses

Optionally, the computer system additionally comprises: a fifth computer component for discarding the packet, if the destination address of the packet does not refer to a DNS server known to be legitimate.

Optionally, the computer system additionally comprises: a fifth computer component for modifying the destination address of the packet to denote a legitimate DNS Server, if the original destination address does not denote a legitimate DNS server.

Optionally, the computer system includes a server.

Optionally, the computer system includes a device comprising a firewall.

Embodiments of the present invention are directed to a computer-usable non-transitory storage medium having a computer program embodied thereon for causing a suitable programmed system for preventing unauthorized use of a DNS channel, by performing the following steps when such program is executed on the system. The steps comprise: receiving a packet; determining whether the packet is a DNS packet or a non-DNS packet; when the packet is a DNS packet, determining whether the destination address of the packet denotes a legitimate DNS server; and, according to whether the destination address of the packet denotes a legitimate DNS server, permitting the packet.

Optionally, the storage medium performs the step of determining whether a DNS server is legitimate by referring to a whitelist of known legitimate DNS server IP addresses.

Optionally, the storage medium additionally performs the step of discarding the packet, if the destination address of the packet does not refer to a DNS server known to be legitimate.

Optionally, the storage medium additionally performs the step of modifying the destination address of the packet to denote a legitimate DNS Server, if the original destination address docs not denote a legitimate DNS server.

Unless otherwise defined herein, all technical and/or scientific terms used herein have the same meaning as commonly understood by one of ordinary skill in the art to which the invention pertains. Although methods and materials similar or equivalent to those described herein may be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF DRAWINGS

Some embodiments of the present invention are herein described, by way of example only, with reference to the accompanying drawings. With specific reference to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

Attention is now directed to the drawings, where like reference numerals or characters indicate corresponding or like components. In the drawings:

FIG. 1 is a diagram illustrating a system environment in which an embodiment of the invention is deployed;

FIG. 2 is a diagram of the architecture of an exemplary gateway machine utilizing the invention;

FIG. 3 is an illustration of the structure of a UDP datagram;

FIG. 4 is a flow diagram showing the process of handling an outbound DNS packet when the invention is embodied in a gateway;

### DETAILED DESCRIPTION OF THE INVENTION

Before explaining at least one embodiment of the invention in detail, it is to be understood that the invention is not necessarily limited in its application to the details of construction and the arrangement of the components and/or methods set forth in the following description and/or illustrated in the drawings. The invention is capable of other embodiments or of being practiced or carried out in various ways.

The present invention may be embodied in a system, method or computer program product. Accordingly, aspects of the present invention may take the form of an entirely hardware embodiment, an entirely software embodiment (including firmware, resident software, micro-code) or an embodiment combining software and hardware aspects that may all generally be referred to herein as a “circuit,” “module” or “system.” Furthermore, aspects of the present invention may take the form of a computer program product embodied in one or more non-transitory computer readable (storage) medium(s) having computer readable program code embodied thereon.

The invention provides, in various embodiments, methods and systems for preventing unauthorized digital content from exiting or entering an organization's network via Domain Name Service (DNS) tunneling. The invention is described in detail and exemplarily for a packet processing gateway (termed the “DNS packet processing gateway”) which processes each outgoing packet before said packet reaches a stateful inspection firewall. However the invention may also be embodied, for example, in a software module residing inside a stateful inspection firewall. Alternatively, the invention may be embodied, for example, in a standalone gateway in a network lacking a stateful inspection firewall (for example a network residing behind a Network Address Translation function). Alternatively, the invention may, for example, be embodied in a virtual server residing in a cloud computing environment.

Some embodiments of the present invention are directed to networks which employ stateful inspection firewalls to enforce policies regarding the traffic which exits and enters the organization's network. The Domain Name Service (DNS) protocol is essential for web browsing and other applications commonly used inside the organization.

The invention addresses this vulnerability of DNS by, for example, enabling the organization to block communication with rogue and unknown DNS servers. The DNS packet processing gateway inspects, for example, each packet exiting the organization to see if it is a DNS request. If so, the DNS packet processing gateway inspects the destination IP address of the DNS packet, and determines whether the address belongs to a legitimate DNS server. To accomplish this the DNS packet processing gateway may, for example, maintain a whitelist of DNS Server IP addresses and deem only those servers to be legitimate DNS Servers. Alternatively, the DNS packet processing gateway may, for example, deem IP addresses that reside in a particular geographic region, or on a particular group of IP subnets to be legitimate. Alternatively, the DNS packet processing gateway may, for example, communicate with an external server to determine which IP addresses are associated with legitimate DNS servers.

Upon encountering a DNS Request packet addressed to a DNS server that is not confirmed to be legitimate, the DNS packet processing gateway, for example, drops the packet. Alternatively, the DNS packet processing gateway may for example, change the destination address of the DNS packet to the IP address of a legitimate DNS server.

In this manner, the potential of attacking though the DNS channel has been mitigated.

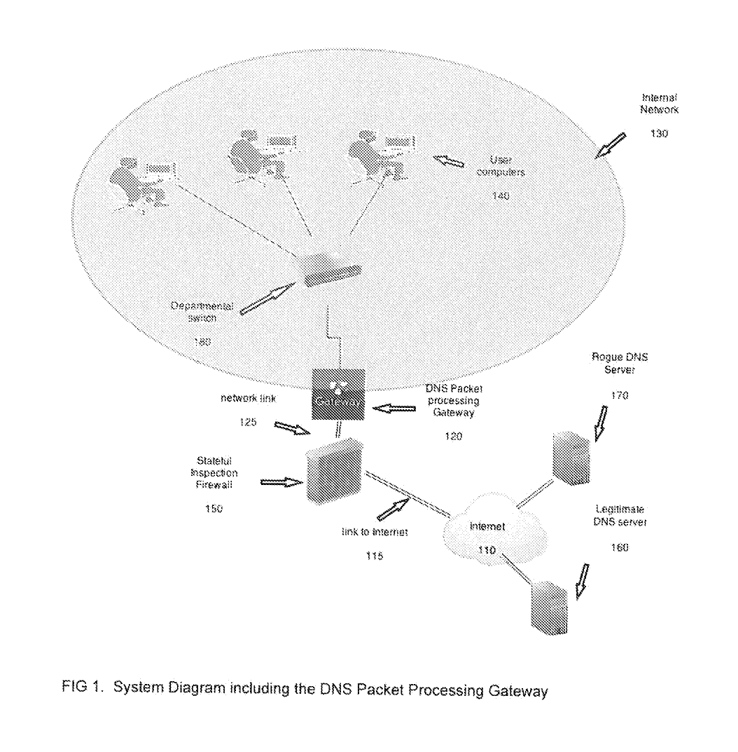

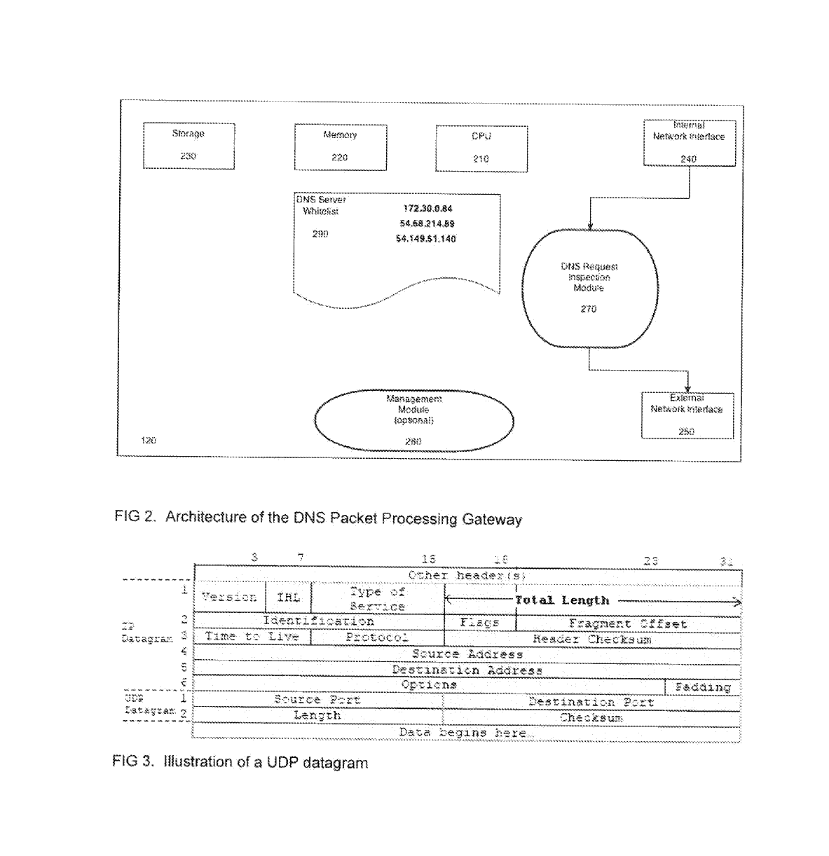

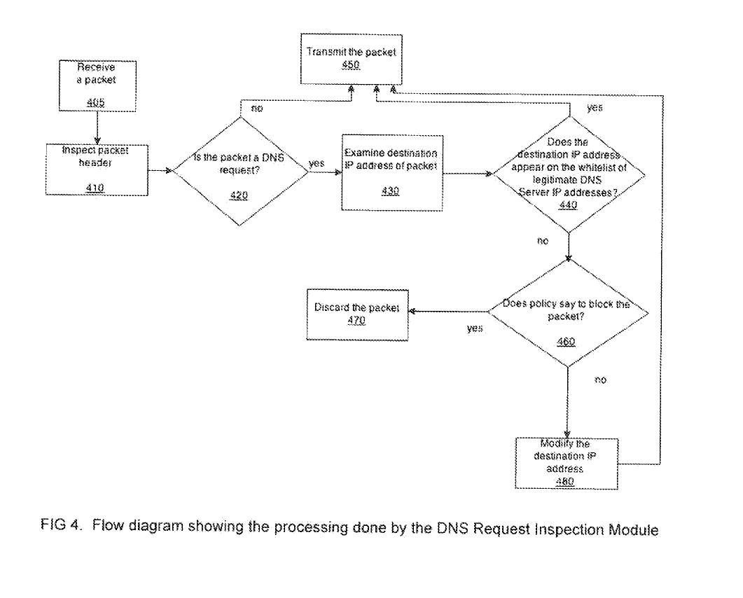

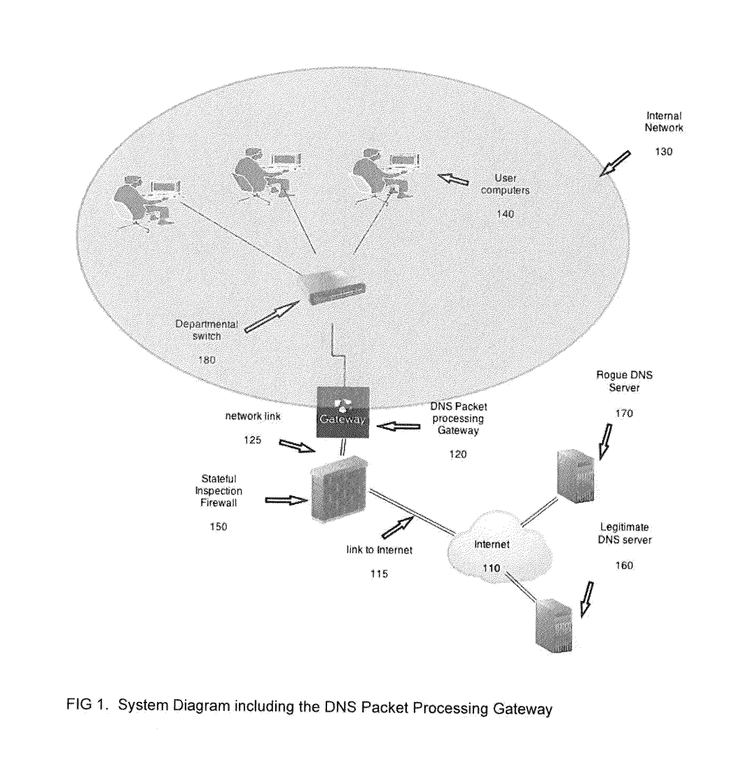

Reference is now made to FIG. 1, which shows an exemplary system environment. The environment includes a DNS packet processing gateway 120 which links via network link 125 to a stateful inspection firewall 150. The network link 125 may be, for example, a LAN connection such as ethernet, or may be, for example, a backplane bus.

The stateful inspection firewall 110 also links to an external network link 115 which may he for example, a broadband or WAN (Wide Area Network) connection, LAN (Local Area Network) connection, local or long-distance wireless link, or other channel capable of transporting packets. The network link 115 also connects to an extra-organizational network such as, for example, the internet or an untrusted portion of the organization's private network, or other channel which can, for example, host a rogue DNS server 170.

The DNS packet processing gateway 120 also links to an internal network 130 to which, for example, the user computers 140 that are to be protected are linked via, for example a departmental switch 180. The user computers 140 may also be, for example, smartphones, tablets, or other types of devices used for accessing email and other electronic communications, and may, for example, be remotely located, for example. when they are attached via a Virtual Private Network (VPN). Similarly, the internal network 130 may include, for example, additional hubs, switches, gateways, wireless segments, or heterogeneous wired components.

The stateful inspection firewall 150 receives, for example, every packet that enters or leaves an organization's network. The stateful inspection firewall 150 enforces the organization's policy by blocking packets that conflict with the policy and forwarding packets that accord with the policy.

The legitimate DNS server 160 is a server, located on the internet, which provides the DNS service. User computers 140 may send DNS request packets to the legitimate DNS server 160 to translate domain names to IP addresses.

There may be a rogue DNS server 170 on the Internet. A rogue DNS server is a server which is not legitimate, and which receives packets that hear the IP header values of DNS requests, and transmits packets which hear the IP header values of DNS responses. However the rogue DNS server 170 may, for example, he able to extract “tunneled” packets from the payloads of the packets that it receives. The rogue DNS server may, for example, also place “tunneled” packets in the payloads of DNS responses that it transmits. Non-complying users or malware may attempt to communicate with the rogue DNS server 170.

Packets may originate from user computers 140 for transmission to, for example, a legitimate DNS server 160 on the Internet 110. After a packet is transmitted, it is received by, for example, a departmental switch 180 which then passes the packet to, for example, the DNS packet processing gateway 120. After the DNS processing, the DNS packet processing gateway 120 forwards the packet to the stateful inspection firewall 150 to enforce the organization's policy on the packet. A packet permitted by the stateful inspection firewall 150 is transmitted over the network link 115 to the interact 110 and then to the legitimate DNS server 160.

A packet originating from, for example, a legitimate DNS server 160 on the internet 110 follows, for example, the reverse path, but is not required to traverse the DNS packet processing gateway.

After a packet is transmitted by the legitimate DNS server 160 to the internet 110, and arrives via the network link 115 at the stateful inspection firewall 150 for enforcement of the organization's policies, the firewall sends the incoming packet to the departmental switch 180 and the switch sends the packet to the specific user's computer 140.

If, however, a user computer 140 transmits a packet to the rogue DNS server 170, it is received by, for example, a departmental switch 180 which then passes the packet to, for example, the DNS packet processing gateway 120. The DNS packet processing gateway 120 determines that the packet is a DNS packet that is not destined to a known DNS server. The DNS packet processing gateway 120 then drops the packet and processing is completed.

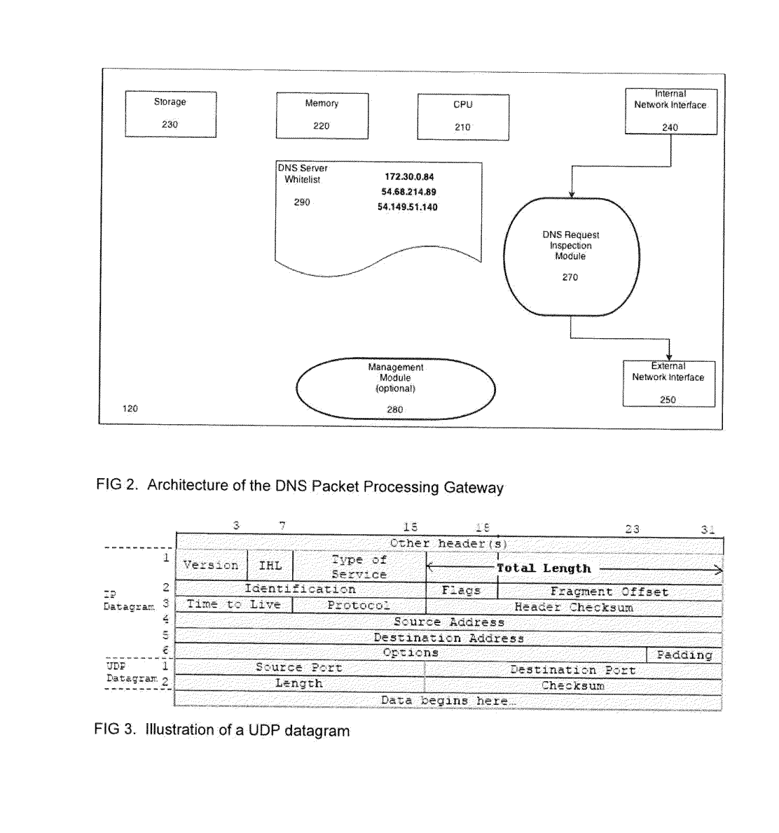

The internal architecture of the DNS packet processing gateway 120 is shown in FIG. 2. The gateway 120 includes a central processing unit (CPU) 210 formed of one or more processors, electronically connected, including in electronic and/or data communication with memory 220, storage 230, network interfaces 240 and 250, DNS request inspection module 270, DNS Server whitelist 290, and optional management module 280.

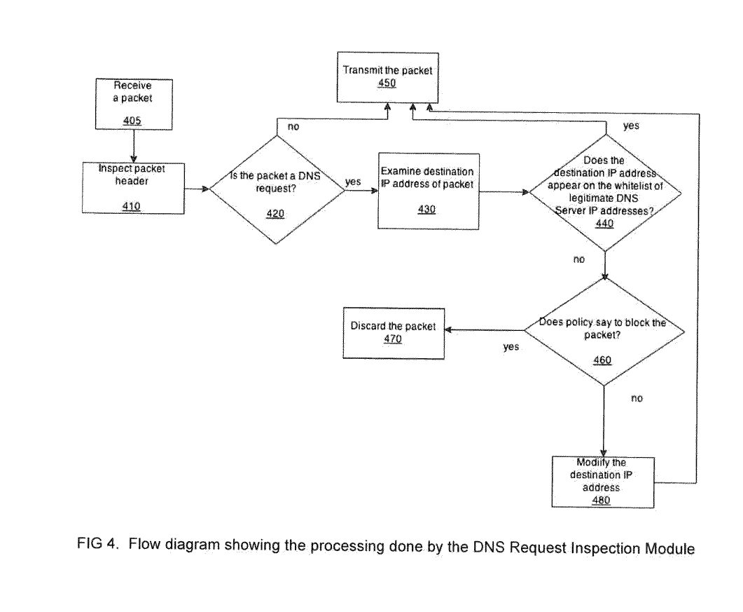

The Central Processing Unit (CPU) 210 is formed of one or more processors, including physical or virtual microprocessors, for performing the gateway 120 functions and operations including, for example controlling the memory 220, storage 230, network interface to internal network 240, network interface to external network 250, DNS request inspection module 270, DNS Server whitelist 290, optional management module 280 along with the process shown in FIG. 4. The processors are, for example, conventional processors, such as those used in servers, computers, and other computerized devices. For example, the processors may include x86 Processors from AMD and Intel, Xeon® and Pentium® processors from Intel, as well as any combinations thereof.

The memory 220 is any conventional memory media. The memory 220 stores machine executable instructions associated with the operation of the components, including, network interfaces 240 and 250, DNS Request Inspection Module 270, DNS Server whitelist 290, optional management module 280 and all instructions for executing the processes of FIG. 4 detailed herein. The processors of the CPU 210, memory 220, and storage 230 although each shown as a single component for representative purposes, may be multiple components, and may be outside of the security gateway 120, and linked to the internal network 130 or internet 110.

The network interface to the internal network 240 is a physical, virtual, or logical data link for communication with computers inside the organization. Similarly, the network interface to the external network 250 is a physical, virtual, or logical data link for communication with computers outside the organization for example on the internet. Alternatively, a gateway may use a single network interface to both the internal and external networks in conjunction with Virtual Local Area Networks (VLANs) or the like.

The DNS request inspection module 270 performs, for example, inspection of incoming packets from the internal network to determine if they are DNS requests, confirming that DNS requests are addressed to DNS servers that are known to be legitimate, blocking of packets addressed to DNS servers that are not known to be legitimate, and forwarding of packets to the external network interface. This procedure is described in detail with reference to FIG. 4.

The DNS Server whitelist 290 is a list of IP addresses that are known to belong to legitimate DNS servers.

The management module 280 is an optional module to enable configuration of the other elements of the DNS packet processing gateway 120. The management module may, for example, provide a graphical user interface and enable configuration of a whitelist of legitimate DNS server IP addresses to be used by the DNS request inspection module 270.

FIG. 3 is an illustration of the structure of a UDP datagram. In the case of a DNS request, the UDP destination port field ill have the value 53.

Attention is now directed to FIG. 4, which shows a flow diagram detailing computer-implemented processes in accordance with embodiments of the disclosed subject matter. Reference is also made to elements shown in FIGS. 1 and 2. The process and subprocesses of FIG. 3 is a computerized processes performed by the system 120. The aforementioned processes and sub-processes can be, for example, performed manually, automatically, or a combination thereof, and, for example, in real time.

The process executed by the DNS request inspection module 270 is illustrated in FIG. 4. In block 405, the module 270 receives a packet from, for example, the internal network interface. In block 410, the module 270 inspects the content of the packet header. In block 420, the module 270 determines if the packet is a DNS request by examining the TCP destination port or UDP destination port in the packet header and evaluating whether these fields match the value 53 which signifies a DNS request, If the packet is not a DNS request, then in block 450 the packet is transmitted on the external network interface. If, however, the packet is a DNS request, control proceeds to block 430 and the destination of the packet is determined by examining, for example, the destination IP address of the DNS request packet. The process moves to block 440, where the module 270 determines if the destination IP address of the DNS request appears in the DNS Server whitelist 290. If the destination IP address does appear in the whitelist, the DNS server is legitimate and control proceeds to block 450 and the packet is transmitted on the external network interface.

If the destination IP address does not appear in the whitelist, then the DNS server cannot be confirmed as legitimate and in block 460, the policy is evaluated to determine the handling of the packet. The policy is, for example, received from the management module 280. If the policy indicates that packets destined to a DNS server whose legitimacy cannot confirmed are supposed to be blocked, then in block 470, the packet is discarded. If the policy indicates that the packets destined to a DNS server whose legitimacy cannot be confirmed are to be redirected rather than blocked, then in block 480 the destination IP address of the packet is modified to the address of, for example, a legitimate DNS server.

The invention has been described in detail for an embodiment that resides in an independent device connected to a firewall via a network connection. Alternatively, the invention may, for example, reside in a hardware module or software module contained within the stateful inspection firewall 150. Alternatively, the invention may, for example, reside in a virtual server running in a cloud computing system.

The invention has been described in detail for an embodiment that determines whether a packet is a DNS packet by examination of the Transport Control Protocol (TCP) destination port or User Datagram Protocol (UDP) destination port. Alternatively, an embodiment may use other mechanisms to identify the DNS packet such as examining an IP header checksum and the like.

The invention has been described in detail for an embodiment that determines the legitimacy of a DNS Server by examination of a packet's IP address (specifically au IPv4 address). Alternatively, the invention may, for example, be embodied in a system using IPv6 wherein legitimacy of a DNS Server is determined, for example, by examining a packet's destination IPv6 address. Alternatively, an embodiment may, for example, examine a destination ethernet address rather than an IP address and, for example maintain a list of ethernet addresses in the whitelist.

The invention has been described in detail for an embodiment that determines the legitimacy of a DNS Server by looking up its IP address in a locally maintained whitelist. Alternatively, an embodiment may, for example, determine legitimacy of a DNS Server according to its absence from a locally maintained blacklist.

Alternatively, an embodiment may, for example, determine legitimacy of a DNS Server by consulting a dynamically maintained whitelist. The dynamically maintained whitelist may, for example, monitor DNS reputation to ensure dynamic removal of a compromised or infected DNS server from the whitelist. Alternatively, the dynamically maintained whitelist may, for example, use a heuristic algorithm based on observing DNS queries, and then remove a server from the whitelist when an anomaly is detected.

Alternatively, an embodiment may, for example, determine legitimacy of a DNS Server by consulting a remote server. Alternatively, an embodiment may, for example, determine legitimacy of a DNS Server by determining its geographic location and the like.

The invention has been described in detail for an embodiment that checks a local policy and then either blocks packets or rewrites the destination address when it is determined that the destination address cannot he confirmed as belonging to a legitimate DNS server. Alternatively, an embodiment may block all such packets. Alternatively an embodiment may only rewrite the destination address of all such packets.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, non-transitory storage media such as a magnetic hard-disk and/or removable media, for storing instructions and/or data. Optionally, a network connection is provided as well. A display and/or a user input device such as a keyboard or mouse are optionally provided as well.

For example, any combination of one or more non-transitory computer readable (storage) medium(s) may be utilized in accordance with the above-listed embodiments of the present invention. The non-transitory computer readable (storage) medium may be a computer readable signal medium or a computer readable storage medium. A computer readable storage medium may be for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

As will be understood with reference to the paragraphs and the referenced drawings, provided above, various embodiments of computer-implemented methods are provided herein, some of which can be performed by various embodiments of apparatuses and systems described herein and some of which can be performed according to instructions stored in non-transitory computer-readable storage media described herein. Still, some embodiments of computer-implemented methods provided herein can be performed by other apparatuses or systems and can be performed according to instructions stored in computer-readable storage media other than that described herein, as will become apparent to those having skill in the art with reference to the embodiments described herein. Any reference to systems and computer-readable storage media with respect to the following computer-implemented methods is provided for explanatory purposes, and is not intended to limit any of such systems and any of such non-transitory computer-readable storage media with regard to embodiments of computer-implemented methods described above. Likewise, any reference to the following computer-implemented methods with respect to systems and computer-readable storage media is provided for explanatory purposes, and is not intended to limit any of such computer-implemented methods disclosed herein.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in sonic alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the singular form “a”, “an” and “the” include plural references unless the context clearly dictates otherwise.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

The above-described processes including portions thereof can be performed by software, hardware and combinations thereof. These processes and portions thereof can be performed by computers, computer-type devices, workstations, processors, micro-processors. other electronic searching tools and memory and other non-transitory storage-type devices associated therewith. The processes and portions thereof can also be embodied in programmable non-transitory storage media, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary, skill m the art to readily adapt other hardware and software as ma be needed to reduce any of the embodiments to practice without undue experimentation and using conventional techniques.

Although the invention has been described in conjunction with specific embodiments thereof, it is evident that many alternatives, modifications and variations will he apparent to those skilled in the art. Accordingly, it is intended to embrace all such alternatives, modifications and variations that fall within the spirit and broad scope of the appended claims.

What is claimed is:

1. A method for preventing unauthorized use of a Domain Name Service (DNS) channel, comprising:
a) receiving a packet
b) determining whether the packet is a DNS packet or a non-DNS packet
c) when the packet is a DNS packet, determining whether the destination address of the packet denotes a legitimate DNS server
d) according to whether the destination address of the packet denotes a legitimate DNS server, permitting the packet.

2. The method of claim 1, wherein a legitimate DNS server is determined by referring to a whitelist of known legitimate DNS server IP addresses

3. The method of claim 1, additionally comprising: discarding the packet, if the destination address of the packet does not refer to a legitimate DNS server.

4. The method of claim 1, additionally comprising: modifying the destination address of the packet to denote a legitimate DNS Server, if the original destination address does not denote a legitimate DNS server.

5. The method of claim 1, wherein the method includes a server.

6. The method of claim 1, wherein the method includes a device comprising a firewall.

7. A computer system for preventing unauthorized use of a Domain Name Service (DNS) channel, comprising:
a storage medium for storing computer components; and
a computerized processor for executing the computer components comprising:
a first computer component for receiving a packet;
a second computer component for determining whether the packet is a DNS packet or a non-DNS packet;
a third computer component for, when the packet is a DNS packet, determining whether the destination address of the packet denotes a legitimate DNS server; and
a fourth computer component for, according to whether the destination address of the packet denotes a legitimate DNS server, permitting the packet.

8. The system of claim 7, wherein the fourth computer component determines a legitimate DNS server is legitimate is by referring to a whitelist of known legitimate DNS server IP addresses

9. The computer system of claim 7, additionally comprising: a fifth computer component for discarding the packet, if the destination address of the packet does not refer to a legitimate DNS server.

10. The computer system of claim 7, additionally comprising: a fifth computer component for modifying the destination address of the packet to denote a legitimate DNS Server, if the original destination address does not denote a legitimate DNS server.

11. The computer system of claim 7, wherein the system includes a server.

12. The computer system of claim 7, wherein the system includes a device comprising a firewall.

13. A computer-usable non-transitory storage medium having a computer program embodied thereon for causing a suitable programmed system to prevent unauthorized use of a DNS channel, by performing the following steps when such program is executed on the system, the steps comprising:
a) receiving a packet
b) determining whether the packet is a DNS packet or a non-DNS packet
c) when the packet is a DNS packet, determining whether the destination address of the packet denotes a legitimate DNS server
d) according to whether the destination address of the packet denotes a legitimate DNS server, permitting the packet.

14. The storage medium of claim 13, wherein a legitimate DNS server is determined by referring to a whitelist of known legitimate DNS server IP addresses

15. The storage medium of claim 13, additionally performing the step of discarding the packet, if the destination address of the packet does not refer to a legitimate DNS server.

16. The storage medium of claim 13, additionally performing the step of modifying the destination address of the packet to denote a legitimate DNS Server, if the original destination address does not denote a legitimate DNS server.
